(19) United States
(12) Patent Application Publication
(10) Pub. No.: US 2020/0247025 A1
(43) Pub. Date: Aug. 6, 2020

(54) METHOD OF MOLDING A PRODUCT INCLUDING AT LEAST ONE TURNING PART INCLUDING AT LEAST ONE OF AN UNDERCUT PART AND A RIGHT-ANGLE PART, PRODUCT MANUFACTURED BY THE METHOD, AND MOLDING DEVICE MANUFACTURING THE PRODUCT BY THE METHOD

(71) Applicant: XRSpace CO., LTD., Taoyuan City (TW)

(72) Inventors: Tang-Yi Huang, Taichung City (TW); Chia-Ching Su, New Taipei City (TW); Chia-Hung Huang, Taoyuan City (TW)

(21) Appl. No.: 16/264,467

(22) Filed: Jan. 31, 2019

(51) Int. Cl. B29C 45/44; B29C 45/26

(52) U.S. Cl. CPC B29C 45/4421; B29C 2045/445; B29C 45/26

(57) ABSTRACT

A method of molding a product including an undercut part or a right-angle part includes providing a female mold, a first male mold and a temporary mold to form a first molding chamber, wherein a boundary between a core and a lifter of the first male mold is located outside the first molding chamber; performing a first injection into the first molding chamber to mold a first portion of the product including the undercut part or the right-angle part; removing the temporary mold; replacing the first male mold with a second male mold to form a second molding chamber, wherein a boundary between a core and a lifter of the second male mold is located outside the second molding chamber; and performing a second injection into the second molding chamber to mold a second portion of the product integrally formed with the first portion of the product.

### BACKGROUND OF THE INVENTION

### 1. Field of the Invention

The present disclosure relates to a method of molding, a product manufactured by the method and a molding device utilizing the method to manufacturing the product, and more particularly, to a method of molding a product including at least one turning part including at least one of an undercut part and a right-angle part, a product manufactured by the method, and a molding device manufacturing the product by the method.

### 2. Description of the Prior Art

Molding is the most commonly used manufacturing process for the fabrication of plastic, glass or metal product. When it is desired to produce a product with an undercut part, it usually requires a sliding lifter attached to a core to form the undercut part and travel sideways with an ejection movement to release the product. For example, please refer to FIG. 1 and FIG. 2. FIG. 1 is a diagram of a mold assembly during a molding process in the prior art. FIG. 2 is a diagram of a product molded by the molding assembly shown in FIG. 1 in the prior art. As shown in FIG. 1 and FIG. 2, in order to mold the product with an undercut part U at a left side, the molding assembly includes a male mold 11 and a female mold 12, and the male mold 11 includes a core 111 and a sliding lifter 112. However, a molding surface of a boundary between the sliding lifter 112 and the core 111 cannot be a smooth surface due to a gap 113 between the sliding lifter 112 and the core 111. Therefore, the gap may be filled with the melted plastic, glass or metal to form a protruding structure on the product during the molding process. The protruding structure can be regarded as a molding defect which causes a negative influence on aesthetic appearance of the product. Especially when the product is made of transparent material, the protruding structure can be observed easily from outside.

Furthermore, as shown in FIG. 1 and FIG. 2, the product includes a slanted wall W with an inner draft angle DA at a right side, so as to facilitate removal of the product from the male mold 11. A product having a vertical wall without a draft angle may offer significant resistance due to friction during the removal. Currently, a sliding lifter and a core also can be provided as a solution for releasing a product with a right-angle part, such as a vertical wall without a draft angle. However, as mentioned above, a protruding structure may be formed due to a gap between the sliding lifter and the core, which causes a negative influence on aesthetic appearance of the product.

There is a need to improve aesthetic appearance of a molding product with an undercut part or a right-angle part.

### SUMMARY OF THE INVENTION

Therefore, it is an objective to provide a method of molding a product including at least one turning part including at least one of an undercut part and a right-angle part, a product manufactured by the method, and a molding device manufacturing the product by the method for solving the aforementioned problem.

In order to achieve the aforementioned objective, the present disclosure discloses a method of molding a product including at least one turning part including at least one of an undercut part and a right-angle part. The method includes providing a female mold, a first male mold including a first core and at least one first lifter obliquely and slidably disposed on the first core, and a temporary mold disposed between the female mold and the first male mold, wherein the temporary mold covers at least one first boundary between the first core and the at least one first lifter of the first male mold in a contacting manner, at least one first molding chamber is defined by the female mold, the first male mold and the temporary mold, and the at least one first boundary is located outside the at least one first molding chamber; performing a first injection into the at least one first molding chamber to mold a first portion of the product including at least one of the at least one turning part; removing the temporary mold; replacing the first male mold with a second male mold including a second core and at least one second lifter obliquely and slidably disposed on the second core, wherein the first portion of the product covers at least one second boundary between the second core and the at least one second lifter of the second male mold in a contacting manner, a second molding chamber is defined by the female mold, the second male mold and the first portion of the product, and the at least one second boundary is located outside the second molding chamber; and performing a second injection into the second molding chamber to mold a second portion of the product integrally formed with the first portion of the product, so as to mold the completed product.

According to an embodiment of the present disclosure, the temporary mold is connected to the first male mold, and removing the temporary mold includes removing the temporary mold by replacing the first male mold with the second male mold.

According to an embodiment of the present disclosure, the temporary mold is connected to the female mold, and removing the temporary mold includes removing the temporary mold by replacing the female mold with another female mold.

According to an embodiment of the present disclosure, performing the first injection into the at least one first molding chamber to mold the first portion of the product including the at least one of the at least one turning part includes performing the first injection into the at least one first molding chamber with a transparent material to mold the first portion of the product including the at least one of the at least one turning part.

According to an embodiment of the present disclosure, performing the second injection into the second molding chamber to mold the second portion of the product integrally formed with the first portion of the product, so as to mold the completed product includes performing the second injection into the second molding chamber with a transparent material to mold the second portion of the product integrally formed with the first portion of the product, so as to mold the completed product.

According to an embodiment of the present disclosure, replacing the first male mold with the second male mold including the second core and the at least one second lifter obliquely and slidably disposed on the second core includes providing the second male mold rotated from the first male mold by 180 degrees.

According to an embodiment of the present disclosure, the at least one turning part includes a plurality of turning parts, and performing the first injection into the at least one first molding chamber to mold the first portion of the product including the at least one of the at least one turning part includes performing the first injection into the at least one first molding chamber to mold the first portion of the product including the plurality of turning parts at different times or at one time.

In order to achieve the aforementioned objective, the present disclosure further discloses a product including at least one turning part including at least one of an undercut part and a right-angle part, and manufactured by the aforementioned method.

In order to achieve the aforementioned objective, the present disclosure further discloses a molding device manufacturing a product including at least one turning part including at least one of an undercut part and a right-angle part by the aforementioned method.

In summary, the present disclosure utilizes the first injection to mold the first portion of the product including at least one turning part and further utilizes the second injection to mold the second portion of the product integrally formed with the first portion of the product. Furthermore, the first boundary between the first core and the first lifter of the first male mold is covered and located outside the first molding chamber during the first injection, and the second boundary between the second core and the second lifter of the second male mold is covered and located outside the second molding chamber during the second injection. Therefore, it effectively solves a problem of a protrusion structure caused by a gap between a lifter and a core in the prior art during a molding process, which improves aesthetic appearance of the product.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a mold assembly during a molding process in the prior art.

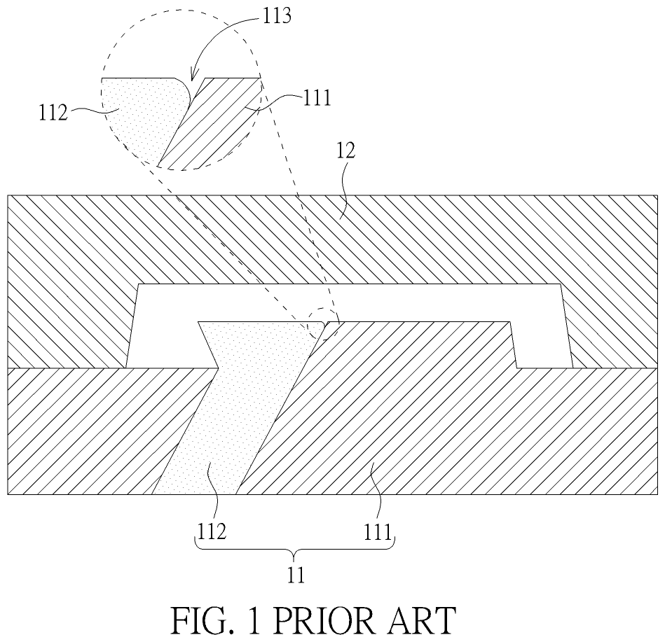

FIG. 2 is a diagram of a product molded by the molding assembly shown in FIG. 1 in the prior art.

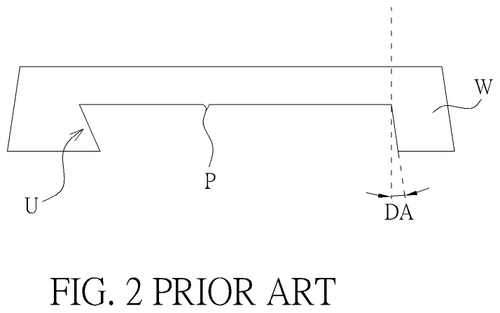

FIG. 3 is a flowchart diagram illustrating a method of molding a product including an undercut part and a slanted wall part with a molding device according to a first embodiment of the present disclosure.

FIG. 4 is a diagram of a first mold assembly before a first injection according to the first embodiment of the present disclosure.

FIG. 5 is a diagram of a second mold assembly before a second injection according to the first embodiment of the present disclosure.

FIG. 6 is a diagram of the product after the second injection according to the first embodiment of the present disclosure.

FIG. 7 is a flow chart diagram illustrating a method of molding a product including two undercut parts and a connecting part with a molding device according to a second embodiment of the present disclosure.

FIG. 8 is a diagram of a first mold assembly before a first injection according to the second embodiment of the present disclosure.

FIG. 9 is a diagram of a second mold assembly before a second injection according to the second embodiment of the present disclosure.

FIG. 10 is a diagram of the product after the second injection according to the second embodiment of the present disclosure.

FIG. 11 is a flow chart diagram illustrating a method of molding a product including two undercut parts and a connecting part with a molding device according to a third embodiment of the present disclosure.

FIG. 12 is a diagram of a first mold assembly before a first injection according to the third embodiment of the present disclosure.

FIG. 13 is a diagram of a second mold assembly before a second injection according to the third embodiment of the present disclosure.

FIG. 14 is a diagram of the product after the second injection according to the third embodiment of the present disclosure.

FIG. 15 is a flow chart diagram illustrating a method of molding a product including a right-angle part and a slanted wall part with a molding device according to a fourth embodiment of the present disclosure.

FIG. 16 is a diagram of a first mold assembly before a first injection according to the fourth embodiment of the present disclosure.

FIG. 17 is a diagram of a second mold assembly before a second injection according to the fourth embodiment of the present disclosure.

FIG. 18 is a diagram of the product after the second injection according to the fourth embodiment of the present disclosure.

FIG. 19 is a flow chart diagram illustrating a method of molding a product including two right-angle parts and a connecting part with a molding device according to a fifth embodiment of the present disclosure.

FIG. 20 is a diagram of a first mold assembly before a first injection according to the fifth embodiment of the present disclosure.

FIG. 21 is a diagram of a second mold assembly before a second injection according to the fifth embodiment of the present disclosure.

FIG. 22 is a diagram of the product after the second injection according to the fifth embodiment of the present disclosure.

FIG. 23 is a flow chart diagram illustrating a method of molding a product including an undercut part, a right-angle part and a connecting part with a molding device according to a sixth embodiment of the present disclosure.

FIG. 24 is a diagram of a first mold assembly before a first injection according to the sixth embodiment of the present disclosure.

FIG. 25 is a diagram of a second mold assembly before a second injection according to the sixth embodiment of the present disclosure.

FIG. 26 is a diagram of the product after the second injection according to the sixth embodiment of the present disclosure.

### DETAILED DESCRIPTION

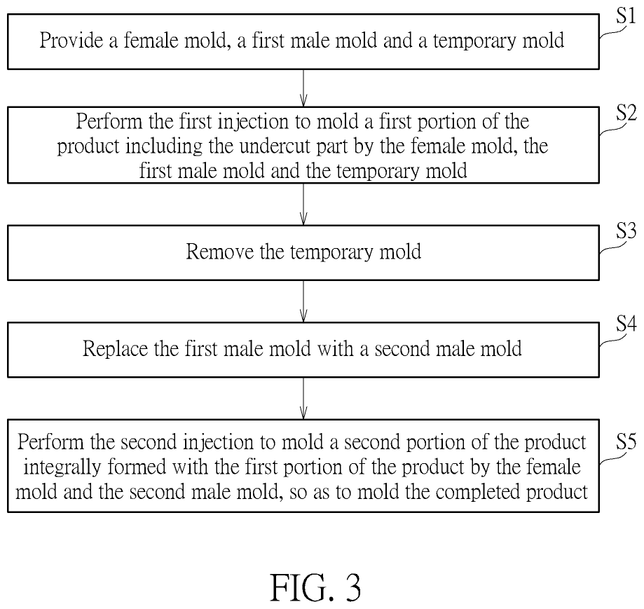

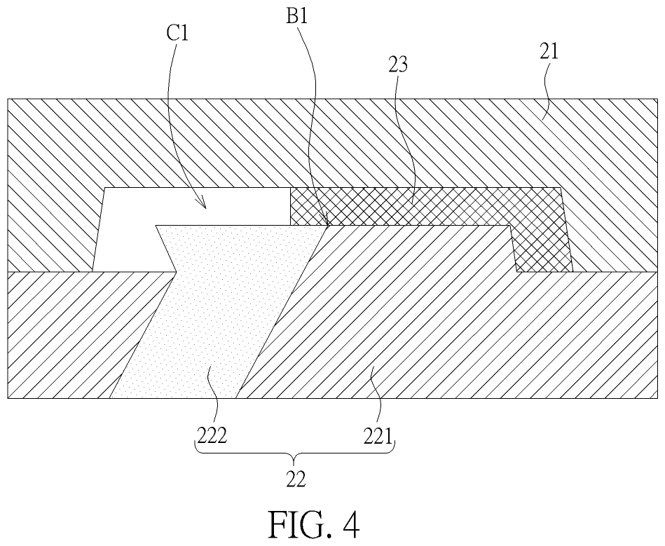

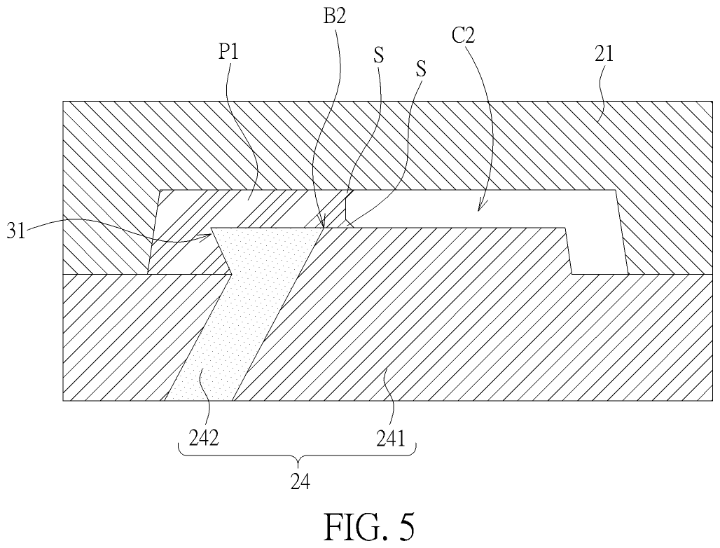

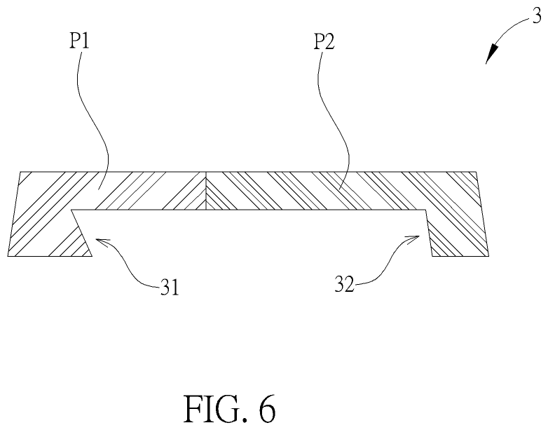

Please refer to FIG. 3 to FIG. 6. FIG. 3 is a flow chart diagram illustrating a method of molding a product 3 including an undercut part 31 and a slanted wall part 32 with a molding device according to a first embodiment of the present disclosure. FIG. 4 is a diagram of a first mold assembly before a first injection according to the first embodiment of the present disclosure. FIG. 5 is a diagram of a second mold assembly before a second injection according to the first embodiment of the present disclosure. FIG. 6 is a diagram of the product 3 after the second injection according to the first embodiment of the present disclosure. As shown in FIG. 3 to FIG. 6, the product 3 includes a turning part at a left side and the slanted wall part 32 at a right side. The slanted wall part 32 can be a right corner of the product 3 having an interior angle greater than 90 degrees. The turning part can be a left corner of the product 3 and include the undercut part 31 whose interior angle is less than 90 degrees, and the method of molding the product 3 with the molding device includes the following steps:

S1: Provide a female mold 21, a first male mold 22 and a temporary mold 23.

S2: Perform the first injection to mold a first portion P1 of the product 3 including the undercut part 31 by the female mold 21, the first male mold 22 and the temporary mold 23.

S3: Remove the temporary mold 23.

S4: Replace the first male mold 22 with a second male mold 24.

S5: Perform the second injection to mold a second portion P2 of the product 3 integrally formed with the first portion P1 of the product 3 by the female mold 21 and the second male mold 24, so as to mold the completed product 3.

Detailed description for the aforementioned steps is provided. The molding device can include the female mold 21, the first male mold 22, the temporary mold 23 and the second male mold 24. The method of molding the product 3 including the undercut part 31 and the slanted wall part 32 can involve a two-stage molding process, such as a double-shot molding process or an insert molding process. Before the first injection, the female mold 21, the first male mold 22 and the temporary mold 23 are provided as the first mold assembly, which is shown in FIG. 4, to form a first molding chamber C1 (step S1). As shown in FIG. 4, the first male mold 22 includes a first core 221 and a first lifter 222 obliquely and slidably disposed on the first core 221. The temporary mold 23 is disposed between the female mold 21 and the first male mold 22 and covers a first boundary B1 between the first core 221 and the first lifter 222 of the first male mold 22 in a contacting manner. In other words, the first molding chamber C1 is defined by the female mold 21, the first male mold 22 and the temporary mold 23, and the first boundary B1 is located outside the first molding chamber C1. Therefore, during the first injection, the first molding chamber C1 is filled with a first material to mold the first portion P1 of the product 3 including the undercut part 31 (step S2).

Afterwards, the first lifter 222 is operated to travel sideways to release the female mold 21 and the first male mold 22. Furthermore, the temporary mold 23 is removed, and the first male mold 22 is replaced by the second male mold 24 (steps S3 and S4), so that the female mold 21, the second male mold 24 and the first portion P1 of the product 3 are provided as the second mold assembly, which is shown in FIG. 5, to form a second molding chamber C2. In this embodiment, the temporary mold 23 can be preferably connected to the first male mold 22. Therefore, the temporary mold 23 can be removed together by replacing the first male mold 22 with the second male mold 24. However, it is not limited to this embodiment. For example, in another embodiment, the temporary mold also can be connected to the female mold, so as to be removed by replacing the female mold with another female mold. Alternatively, in another embodiment, the temporary mold can be an independent mold separated from the first male mold and the female mold, so as to be removed independently.

Furthermore, as shown in FIG. 5, the second male mold 24 includes a second core 241 and a second lifter 242 obliquely and slidably disposed on the second core 241. The second lifter 242 has a thinner thickness than a thickness of the first lifter 241. The first portion P1 of the product 3 is located between the female mold 21 and the second male mold 24, and a second boundary B2 between the second core 241 and the second lifter 242 of the second male mold 24 is covered by the first portion P1 of the product 3 in a contacting manner. In other words, the second molding chamber C2 is defined by the female mold 21, the second male mold 24 and the first portion P1 of the product 3 and adjacent to the first molding chamber C1, and the second boundary B2 is located outside the second molding chamber C2. Therefore, during the second injection, the second molding chamber C2 is filled with a second material to mold the second portion P2 of the product 3 including the slanted wall part 32 and integrally formed with the first portion P1 of the product 3 (step S5), so as to mold the completed product 3 including the undercut part 31 and the slanted wall part 32, which is shown in FIG. 6. Besides, the first material and the second material can be the same material and a transparent material.

From the above, the first boundary B1 between the first lifter 222 and the first core 221 is located outside the first molding chamber C1 during the first injection of molding the first portion P1 of the product 3 including the undercut part 31, and the second boundary B2 between the second lifter 242 and the second core 241 is located outside the second molding chamber C2 during the second injection of molding the second portion P2 of the product 3 including the slanted wall part 32. All surfaces of the first portion P1 of the product 3 can be smooth without interference of the first boundary B1 between the first lifter 222 and the first core 221 even if there is a gap, which is small and not shown in figures, formed on the first boundary B1 between the first lifter 222 and the first core 221, and all surfaces of the second portion P2 of the product 3 can be smooth without interference of the second boundary B2 between the second core 241 and the second lifter 242 even if there is a gap, which is small and not shown in figures, formed on the second boundary B2 between the second core 241 and the second lifter 242. Therefore, it effectively solves a problem of a protrusion structure caused by a gap between a lifter and a core in the prior art during a molding process, which improves aesthetic appearance of the product 3 especially when the product 3 is made of transparent material, i.e., both of the first material and the second material are transparent. In conclusion, there is no protrusion structure formed on the product 3, which can be observed through the transparent material, during the molding process of the present disclosure.

Besides, it should be noticed that, as shown in FIG. 4 to FIG. 6, after the first injection, the first portion P1 of the product 3 may include two protrusions S on a left side due to a gap between the temporary mold 23 and the female mold 21 and a gap between the temporary mold 23 and the first slider 222, which are small and not shown in figures. However, the two protrusions S can be melted and integrally formed with the second portion P2 of the product 3 during the second injection. It cannot affect aesthetic appearance of the product 3.

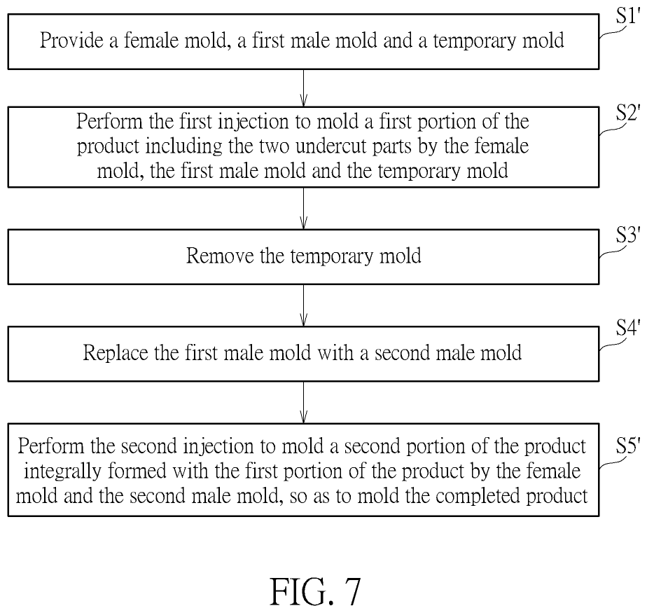

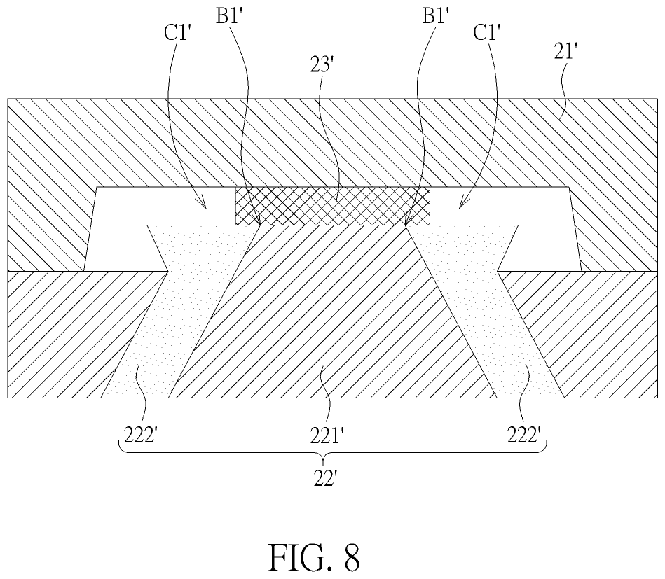

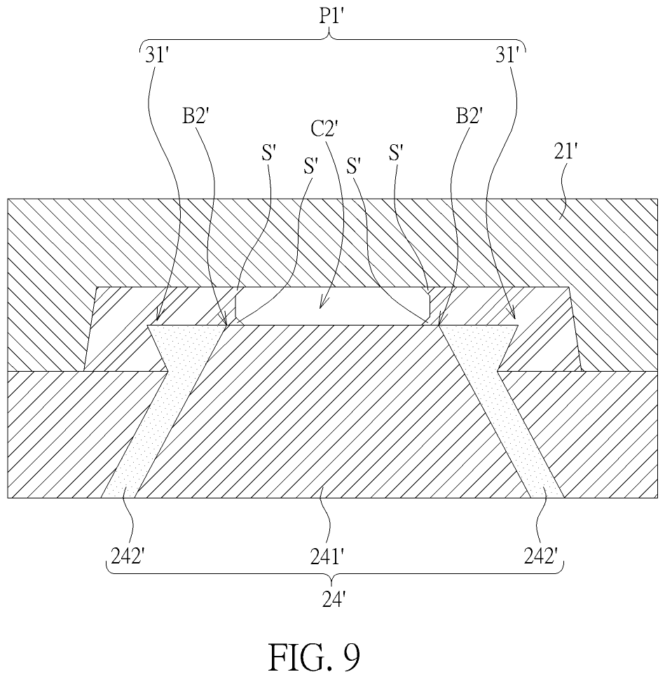

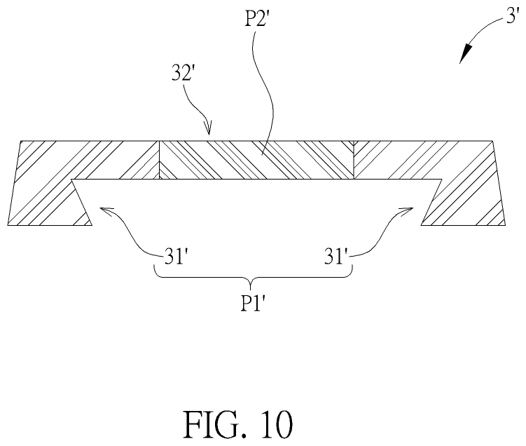

Please refer to FIG. 7 to FIG. 10. FIG. 7 is a flow chart diagram illustrating a method of molding a product 3′ including two undercut parts 31′ and a connecting part 32′ with a molding device according to a second embodiment of the present disclosure. FIG. 8 is a diagram of a first mold assembly before a first injection according to the second embodiment of the present disclosure. FIG. 9 is a diagram of a second mold assembly before a second injection according to the second embodiment of the present disclosure. FIG. 10 is a diagram of the product 3′ after the second injection according to the second embodiment of the present disclosure. As shown in FIG. 7 to FIG. 10, different from the first embodiment, the product 3′ of this embodiment includes two turning parts at a left side and a right side and the connecting part 32′. The two turning parts can be a left corner and a right corner of the product 3, and each turning part can include the undercut part 31′ whose interior angle is less than 90 degrees. The connecting part 32′ is connected to the two undercut parts 31′, and the method of molding the product 3′ with the molding device includes the following steps:

S1′: Provide a female mold 21′, a first male mold 22′ and a temporary mold 23′.

S2′: Perform the first injection to mold a first portion P1′ of the product 3′ including the two undercut parts 31′ by the female mold 21′, the first male mold 22′ and the temporary mold 23′.

S3′: Remove the temporary mold 23′.

S4′: Replace the first male mold 22′ with a second male mold 24′.

S5′: Perform the second injection to mold a second portion P2′ of the product 3′ integrally formed with the first portion P1′ of the product 3′ by the female mold 21′ and the second male mold 24′, so as to mold the completed product 3′.

Detailed description for the aforementioned steps is provided. The molding device can include the female mold 21′, the first male mold 22′, the temporary mold 23′ and the second male mold 24′. Before the first injection, the female mold 21′, the first male mold 22′ and the temporary mold 23′ are provided as the first mold assembly, which is shown in FIG. 8, to form two first molding chambers C1′ (step S1′). As shown in FIG. 8, the first male mold 22′ includes a first core 221′ and two first lifters 222′ obliquely and slidably disposed on the first core 221′. The temporary mold 23′ is disposed between the female mold 21′ and the first male mold 22′ and covers two first boundaries B1′ between the first core 221′ and the two first lifters 222′ of the first male mold 22′ in a contacting manner. In other words, the two first molding chambers C1′ are defined by the female mold 21′, the first male mold 22′ and the temporary mold 23′, and the two first boundaries B1′ are located outside the two first molding chambers C1′. Therefore, during the first injection, the two first molding chambers C1′ are filled with a first material to mold the first portion P1′ of the product 3′ including the two undercut parts 31′ (step S2′). In this embodiment, the first portion P1′ of the product 3′ including the two undercut parts 31′ can be molded by one-time injection. However, it is not limited to this embodiment. For example, in another embodiment, the first portion P1′ of the product 3′ including the two undercut parts 31′ can be molded by multiple injections at different times. It depends on practical demands.

Afterwards, the temporary mold 23′ is removed, and the first male mold 22′ is replaced by the second male mold 24′ (steps S3′ and S4′), so that the female mold 21′, the second male mold 24′ and the first portion P1′ of the product 3′ are provided as the second mold assembly, which is shown in FIG. 9, to form a second molding chamber C2′. Similar to the first embodiment, the temporary mold 23′ of this embodiment can be preferably connected to the first male mold 22′. Therefore, the temporary mold 23′ can be removed together by replacing the first male mold 22′ with the second male mold 24′. However, it is not limited to this embodiment. Furthermore, the second male mold 24′ includes a second core 241′ and two second lifters 242′ obliquely and slidably disposed on the second core 241′. The first portion P1′ of the product 3′ is located between the female mold 21′ and the second male mold 24′, and two second boundaries B2′ between the second core 241′ and the two second lifters 242′ of the second male mold 24′ are covered by the first portion P1′ of the product 3′ in a contacting manner. In other words, the second molding chamber C2′ is defined by the female mold 21′, the second male mold 24′ and the first portion P1′ of the product 3′, and the two second boundaries B2′ are located outside the second molding chamber C2′. Therefore, during the second injection, the second molding chamber C2′ is filled with a second material to mold the second portion P2′ of the product 3′ including the connecting part 32′ and integrally formed with the first portion P1′ of the product 3′ (step S5′), so as to mold the completed product 3′ including the two undercut parts 31′ and the connecting part 32′, which is shown in FIG. 10. All surfaces of the first portion P1′ of the product 3′ can be smooth without interference of the two first boundaries B1′ between the first core 221′ and the two first lifters 222′, and all surfaces of the second portion P2 of the product 3′ can be smooth without interference of the two second boundaries B2′ between the second core 241′ and the two second lifters 242′. Therefore, there is no protrusion structure formed on the product 3′.

Besides, similarly, as shown in FIG. 8 to FIG. 10, after the first injection, the first portion P1′ of the product 3′ may include protrusions S′ due to gaps between the temporary mold 23′ and the female mold 21′ and gaps between the temporary mold 23′ and the two first sliders 222′, which are not shown in figures. However, the protrusions S′ can be melted and integrally formed with the second portion P2′ of the product 3′ during the second injection. It cannot affect aesthetic appearance of the product 3′.

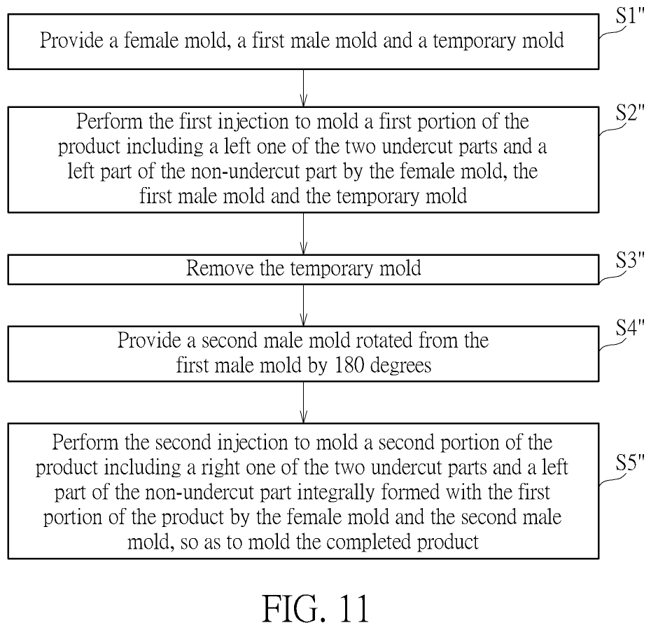

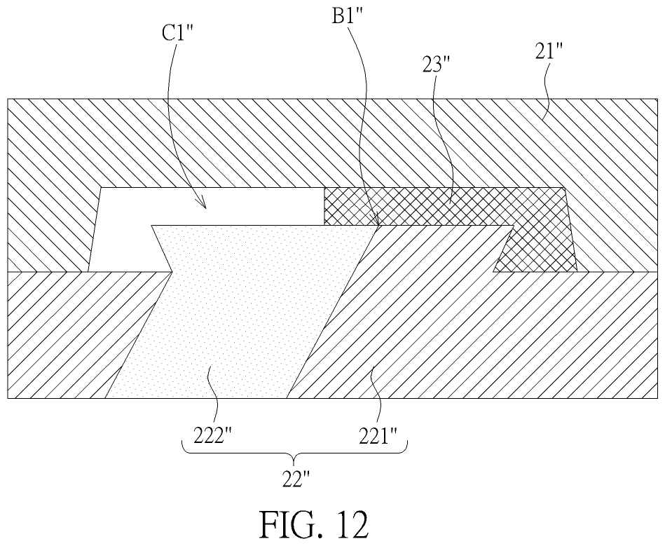

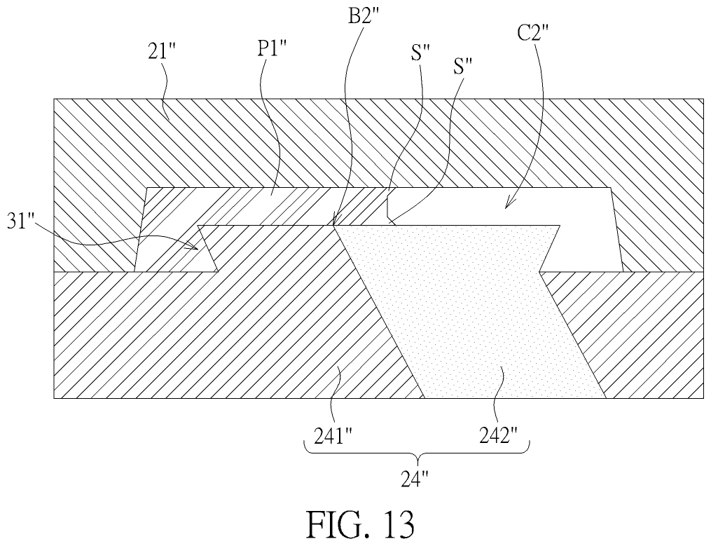

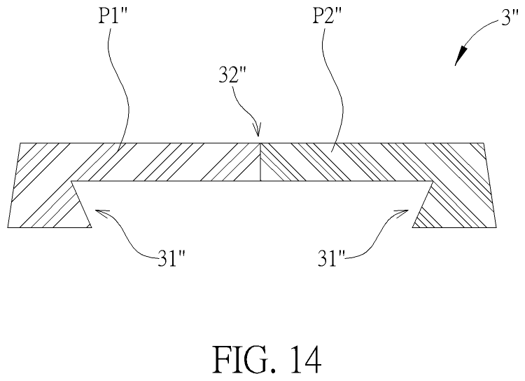

Please refer to FIG. 11 to FIG. 14. FIG. 11 is a flow chart diagram illustrating a method of molding a product 3″ including two undercut parts 31″ and a connecting part 32″ with a molding device according to a third embodiment of the present disclosure. FIG. 12 is a diagram of a first mold assembly before a first injection according to the third embodiment of the present disclosure. FIG. 13 is a diagram of a second mold assembly before a second injection according to the third embodiment of the present disclosure. FIG. 14 is a diagram of the product 3″ after the second injection according to the third embodiment of the present disclosure. As shown in FIG. 11 to FIG. 14, different from the aforementioned embodiments, the product 3″ of this embodiment includes two turning parts at a left side and a right side and the connecting part 32″. The two turning parts can be a left corner and a right corner of the product 3″, and each turning part can include the undercut part 31″ whose interior angle is less than 90 degrees. The connecting part 32″ is connected to the two undercut parts 31″, and the method of molding the product 3″ with the molding device includes the following steps:

S1″: Provide a female mold 21″, a first male mold 22″ and a temporary mold 23″.

S2″: Perform the first injection to mold a first portion P1″ of the product 3″ including a left one of the two undercut parts 31″ and a left portion of the connecting part 32″ by the female mold 21″, the first male mold 22″ and the temporary mold 23″.

S3″: Remove the temporary mold 23″.

S4″: Provide a second male mold 24″ rotated from the first male mold 22″ by 180 degrees.

S5″: Perform the second injection to mold a second portion P2″ of the product 3″ including a right one of the two undercut parts 31″ and a right portion of the connecting part 32″ integrally formed with the first portion P1″ of the product 3″ by the female mold 21″ and the second male mold 24″, so as to mold the completed product 3″.

Detailed description for the aforementioned steps is provided. The molding device can include the female mold 21″, the first male mold 22″, the temporary mold 23″ and the second male mold 24″. Before the first injection, the female mold 21″, the first male mold 22″ and the temporary mold 23″ are provided as the first mold assembly, which is shown in FIG. 12, to form a first molding chamber C1″ (step S1″). As shown in FIG. 12, the first male mold 22″ includes a first core 221″ and a first lifter 222″ obliquely and slidably disposed on the first core 221″. The temporary mold 23″ is disposed between the female mold 21″ and the first male mold 22″ and covers a first boundary B1″ between the first core 221″ and the first lifter 222″ of the first male mold 22″ in a contacting manner. In other words, the first molding chamber C1″ is defined by the female mold 21″, the first male mold 22″ and the temporary mold 23″, and the first boundary B1″ is located outside the first molding chamber C1“. Therefore, during the first injection, the first molding chamber C1” is filled with a first material to mold the first portion P1″ of the product 3″ including the left one of the two undercut parts 31″ and the left portion of the connecting part 32″ (step S2″).

Afterwards, the temporary mold 23″ is removed, and the first male mold 22″ is replaced by the second male mold 24″, which is rotated from the first male mold 22″ by 180 degrees, (steps S3″ and S4″), so that the female mold 21″, the second male mold 24″ and the first portion P1″ of the product 3″ are provided as the second mold assembly, which is shown in FIG. 13, to form a second molding chamber C2″. In this embodiment, the temporary mold 23″ can preferably be an independent mold. Therefore, the temporary mold 23″ can be removed independently. However, it is not limited to this embodiment. As shown in FIG. 13, the second male mold 24″ includes a second core 241″ and a second lifter 242″ obliquely and slidably disposed on the second core 241″. Since the second male mold 24″ is rotated from the first male mold 22″ by 180 degrees, the second core 241″ and the second lifter 242″ of the second male mold 24″ are substantially opposite to the first core 221″ and the first lifter 222″ of the first male mold 22″. The first portion P1″ of the product 3″ is located between the female mold 21″ and the second male mold 24″, and a second boundary B2″ between the second core 241″ and the second lifter 242″ of the second male mold 24″ is covered by the first portion P1″ of the product 3″ in a contacting manner. In other words, the second molding chamber C2″ is defined by the female mold 21″, the second male mold 24″ and the first portion P1″ of the product 3″, and the second boundary B2″ is located outside the second molding chamber C2″. Therefore, during the second injection, the second molding chamber C2″ is filled with a second material to mold the second portion P2″ of the product 3″ including the right one of the two undercut part 31″ and the right portion of the connecting part 32″ and integrally formed with the first portion P1″ of the product 3″ (step S5″), so as to mold the completed product 3″ including the two undercut parts 31″ and the connecting part 32″, which is shown in FIG. 14. All surfaces of the first portion P1″ of the product 3″ can be smooth without interference of the first boundary B1″ between the first core 221″ and the first lifter 222″, and all surfaces of the second portion P2″ of the product 3″ can be smooth without interference of the second boundary B2″ between the second core 241″ and the second lifter 242″. Therefore, there is no protrusion structure formed on the product 3″.

Besides, similarly, as shown in FIG. 11 to FIG. 14, after the first injection, the first portion P1″ of the product 3″ may include protrusions S″ due to a gap between the temporary mold 23″ and the female mold 21″ and a gap between the temporary mold 23″ and the first sliders 222″, which are not shown in figures. However, the protrusions S″ can be melted and integrally formed with the second portion P2″ of the product 3″ during the second injection. It cannot affect aesthetic appearance of the product 3″.

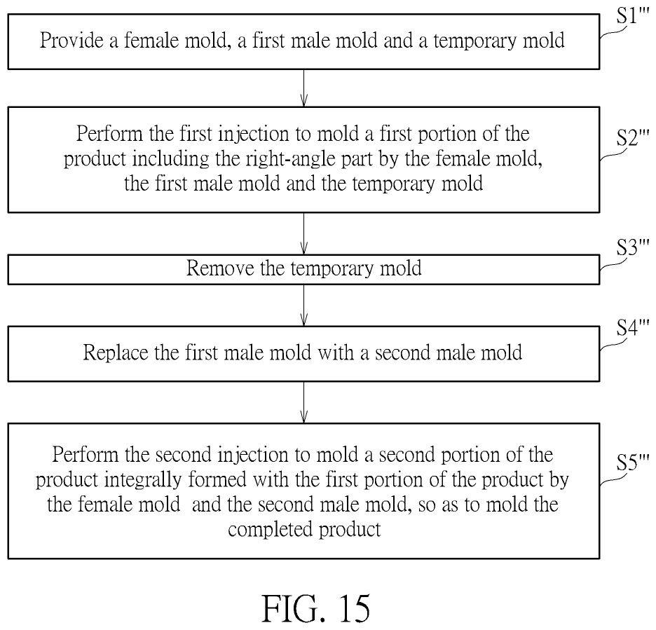

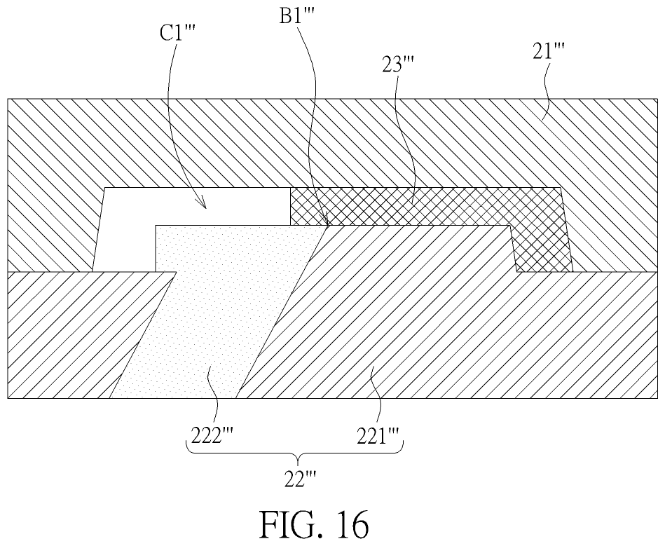

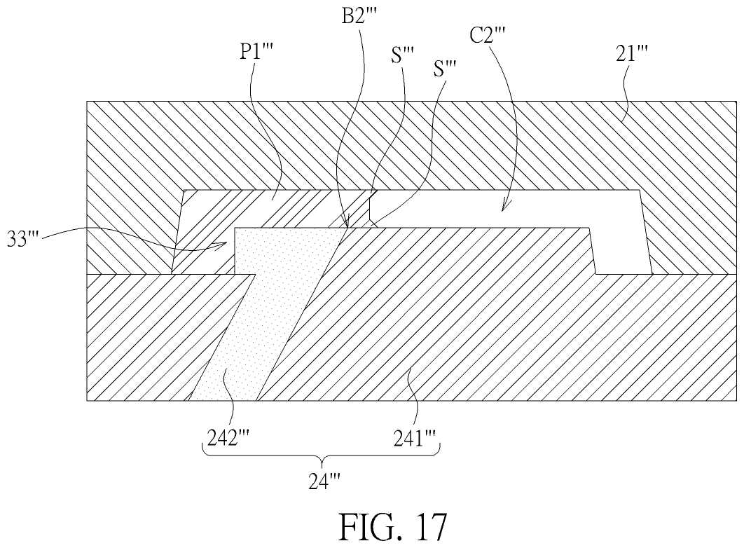

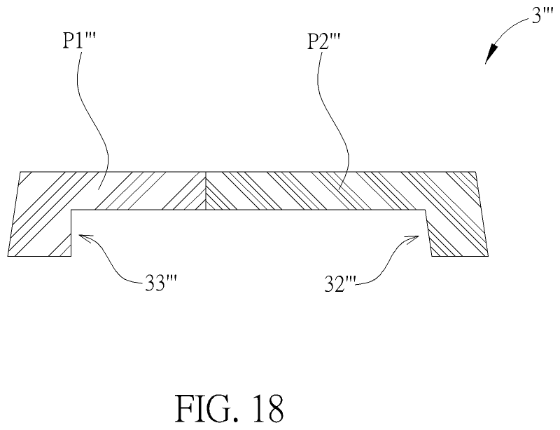

Please refer to FIG. 15 to FIG. 18. FIG. 15 is a flow chart diagram illustrating a method of molding a product 3′″ including a right-angle part 33′″ and an slanted wall part 32′″ with a molding device according to a fourth embodiment of the present disclosure. FIG. 16 is a diagram of a first mold assembly before a first injection according to the fourth embodiment of the present disclosure. FIG. 17 is a diagram of a second mold assembly before a second injection according to the fourth embodiment of the present disclosure. FIG. 18 is a diagram of the product 3′″ after the second injection according to the fourth embodiment of the present disclosure. As shown in FIG. 15 to FIG. 18, different from the aforementioned embodiments, the product 3′″ of this embodiment includes a turning part at a left side and the slanted wall part 32″. The slanted wall part 32″ can be a right corner of the product 3′″ having an interior angle greater than 90 degrees. The turning part can be a left corner of the product 3′″ and include the right-angle part 33′″ whose interior angle is equal to 90 degrees. The method of molding the product 3′″ with the molding device of this embodiment can be similar to the one of the first embodiment. A first portion P1′″ of the product 3′″ including the right-angle part 33′″ can be molded by performing a first injection into a first molding chamber C1′″ shown in FIG. 16. A second portion P2′″ of the product 3′″ including the slanted wall part 32′″ can be molded and integrally formed with the first portion P1′″ by performing the second injection into a second molding chamber C2′″ shown in FIG. 17, so as to mold the completed product 3′″. Detailed description is omitted herein for simplicity.

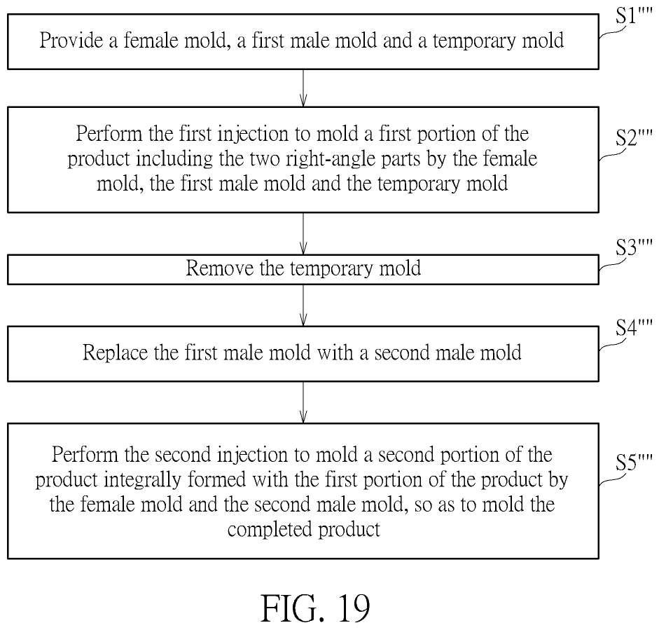

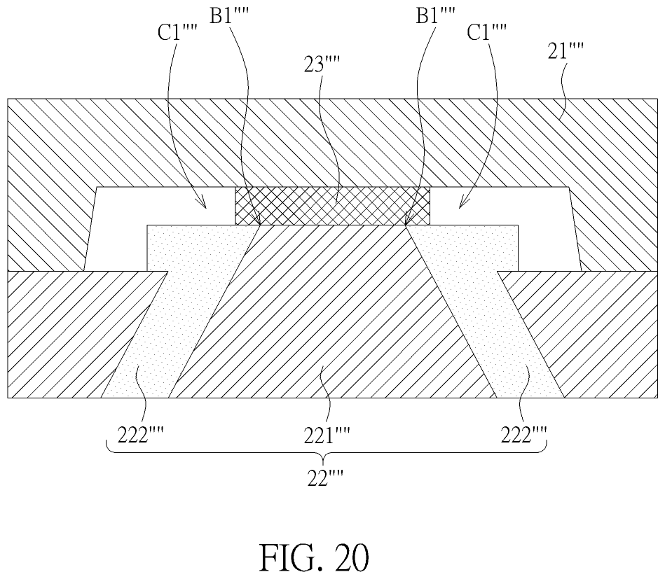

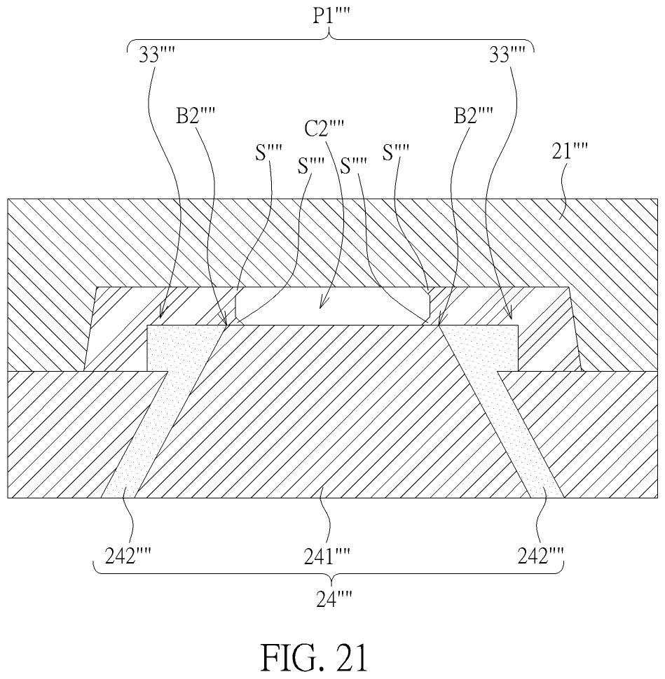

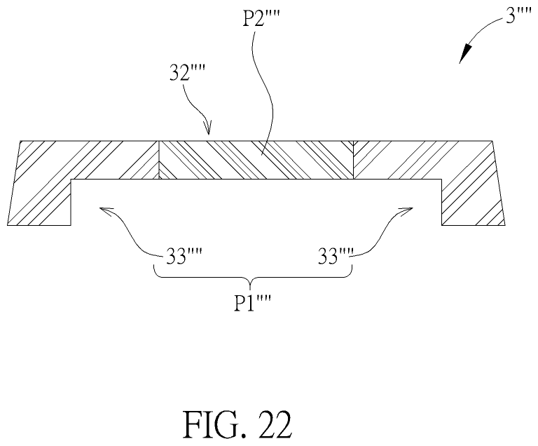

Please refer to FIG. 19 to FIG. 22. FIG. 19 is a flow chart diagram illustrating a method of molding a product 3″″ including two right-angle parts 33″″ and a connecting part 32″″ with a molding device according to a fifth embodiment of the present disclosure. FIG. 20 is a diagram of a first mold assembly before a first injection according to the fifth embodiment of the present disclosure. FIG. 21 is a diagram of a second mold assembly before a second injection according to the fifth embodiment of the present disclosure. FIG. 22 is a diagram of the product 3″″ after the second injection according to the fifth embodiment of the present disclosure. As shown in FIG. 19 to FIG. 22, different from the aforementioned embodiments, the product 3″″ of this embodiment includes two turning parts at a left side and at a right side and the connecting part 32″″. The two turning parts can be a left corner and a right corner of the product 3″″, and each turning part can include the right-angle part 33″″ whose interior angle is equal to 90 degrees. The connecting part 32″″ is connected to the two right-angle parts 33″″. The method of molding the product 3″″ with the molding device of this embodiment can be similar to the one of the second embodiment. A first portion P1″″ of the product 3″″ including the two right-angle parts 33″″ can be molded by performing a first injection into two first molding chambers C1″″ shown in FIG. 19. A second portion P2″″ of the product 3″″ including the connecting part 32″″ can be molded and integrally formed with the first portion P1″″ by performing the second injection into a second molding chamber C2″″ shown in FIG. 20, so as to mold the completed product 3″″. Detailed description is omitted herein for simplicity. Furthermore, understandably, the undercut part 31″″ and the right-angle part 33″″ can be molded at different times or at one time. However, it is not limited to this embodiment. The product 3″″ of this embodiment also can be molded by providing a second male mold rotated from the first male mold by 180 degrees, which is similar to the method of the third embodiment. Detailed description is omitted herein for simplicity.

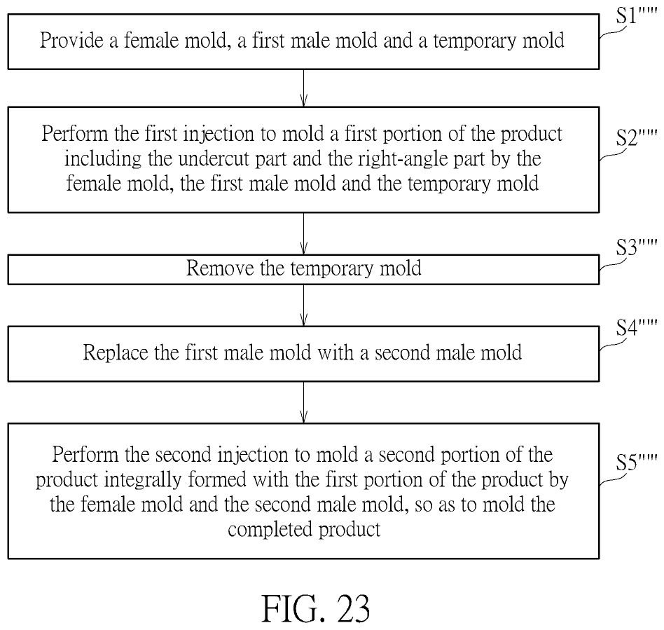

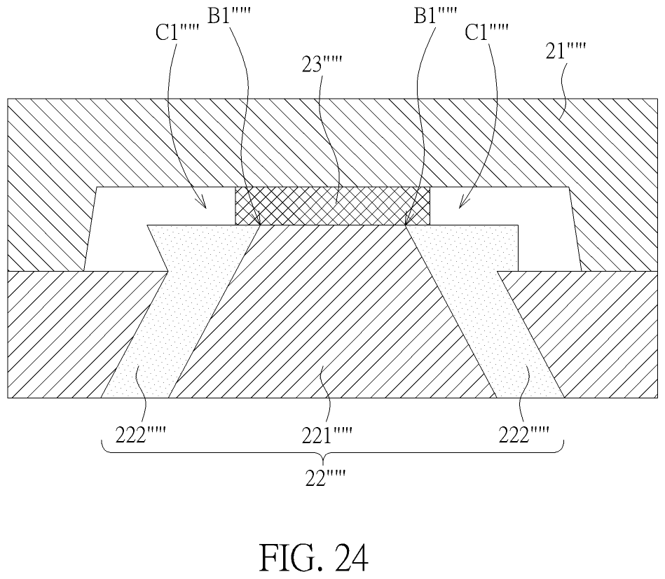

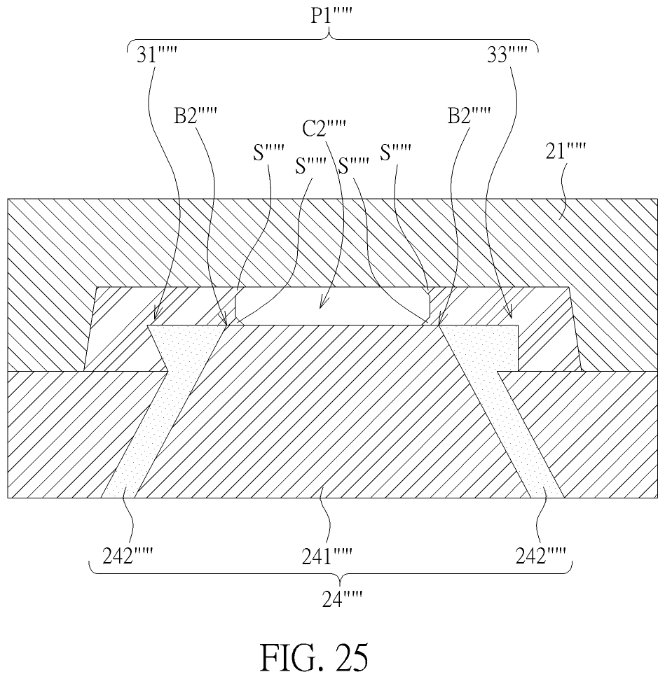

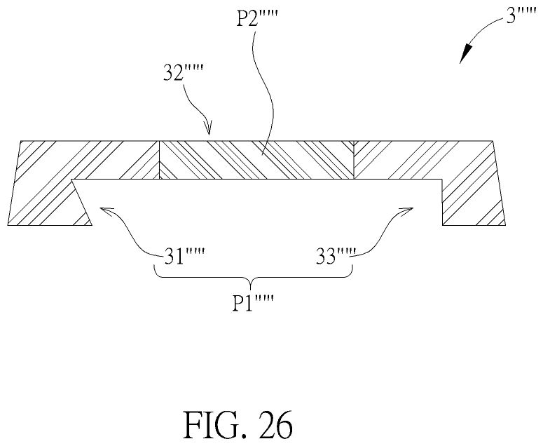

Please refer to FIG. 23 to FIG. 26. FIG. 23 is a flow chart diagram illustrating a method of molding a product 3′″″ including an undercut part 31′″″ a right-angle part 33′″″ and a connecting part with a molding device according to a sixth embodiment of the present disclosure. FIG. 24 is a diagram of a first mold assembly before a first injection according to the sixth embodiment of the present disclosure. FIG. 25 is a diagram of a second mold assembly before a second injection according to the sixth embodiment of the present disclosure. FIG. 26 is a diagram of the product 3′″″ after the second injection according to the sixth embodiment of the present disclosure. As shown in FIG. 23 to FIG. 26, different from the aforementioned embodiments, the product 3′″″ of this embodiment includes two turning parts at a left side and at a right side and the connecting part 32′″″. The two turning parts can be a left corner and a right corner of the product 3′″″. The turning part at the left side can include the undercut part 31′″″ whose interior angle is less than 90 degrees, and the turning part at the right side can include the right-angle part 33′″″ whose interior angle is equal to 90 degrees. The connecting part 32′″″ is connected to the undercut part 31′″″ and the right-angle part 33′″″. The method of molding the product 3 with the molding device of this embodiment can be similar to the one of the second embodiment. A first portion P1′″″ of the product 3′″″ including the undercut part 31′″″ and the right-angle part 33′″″ can be molded by performing a first injection into two first molding chambers C1′″″ shown in FIG. 24. A second portion P2′″″ of the product 3′″″ including the connecting part 32′″″ can be molded and integrally formed with the first portion P1′″″ by performing the second injection into a second molding chamber C2′″″ shown in FIG. 25, so as to mold the completed product 3′″″. Detailed description is omitted herein for simplicity. Besides, understandably, the undercut part 31′″″ and the right-angle part 33′″″ can be molded at different times or at one time.

In contrast to the prior art, the present disclosure utilizes the first injection to mold the first portion of the product including at least one turning part and further utilizes the second injection to mold the second portion of the product integrally formed with the first portion of the product. Furthermore, the first boundary between the first core and the first lifter of the first male mold is covered and located outside the first molding chamber during the first injection, and the second boundary between the second core and the second lifter of the second male mold is covered and located outside the second molding chamber during the second injection. Therefore, it effectively solves a problem of a protrusion structure caused by a gap between a lifter and a core in the prior art during a molding process, which improves aesthetic appearance of the product.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method of molding a product comprising at least one turning part comprising at least one of an undercut part and a right-angle part, the method comprising:
providing a female mold, a first male mold comprising a first core and at least one first lifter obliquely and slidably disposed on the first core, and a temporary mold disposed between the female mold and the first male mold, wherein the temporary mold covers at least one first boundary between the first core and the at least one first lifter of the first male mold in a contacting manner, at least one first molding chamber is defined by the female mold, the first male mold and the temporary mold, and the at least one first boundary is located outside the at least one first molding chamber;
performing a first injection into the at least one first molding chamber to mold a first portion of the product comprising at least one of the at least one turning part;
removing the temporary mold;
replacing the first male mold with a second male mold comprising a second core and at least one second lifter obliquely and slidably disposed on the second core, wherein the first portion of the product covers at least one second boundary between the second core and the at least one second lifter of the second male mold in a contacting manner, a second molding chamber is defined by the female mold, the second male mold and the first portion of the product, and the at least one second boundary is located outside the second molding chamber; and
performing a second injection into the second molding chamber to mold a second portion of the product integrally formed with the first portion of the product, so as to mold the completed product.

2. The method of claim 1, wherein the temporary mold is connected to the first male mold, and removing the temporary mold comprising:
removing the temporary mold by replacing the first male mold with the second male mold.

3. The method of claim 1, wherein the temporary mold is connected to the female mold, and removing the temporary mold comprising:
removing the temporary mold by replacing the female mold with another female mold.

4. The method of claim 1, wherein performing the first injection into the at least one first molding chamber to mold the first portion of the product comprising the at least one of the at least one turning part comprising:
performing the first injection into the at least one first molding chamber with a transparent material to mold the first portion of the product comprising the at least one of the at least one turning part.

5. The method of claim 1, wherein performing the second injection into the second molding chamber to mold the second portion of the product integrally formed with the first portion of the product, so as to mold the completed product comprising:
performing the second injection into the second molding chamber with a transparent material to mold the second portion of the product integrally formed with the first portion of the product, so as to mold the completed product.

6. The method of claim 1, wherein replacing the first male mold with the second male mold comprising the second core and the at least one second lifter obliquely and slidably disposed on the second core comprising:
providing the second male mold rotated from the first male mold by 180 degrees.

7. The method of claim 1, wherein the at least one turning part comprises a plurality of turning parts, and performing the first injection into the at least one first molding chamber to mold the first portion of the product comprising the at least one of the at least one turning part comprises:
performing the first injection into the at least one first molding chamber to mold the first portion of the product comprising the plurality of turning parts at different times or at one time.

8. A product comprising at least one turning part comprising at least one of an undercut part and a right-angle part, and manufactured by a method comprising:
providing a female mold, a first male mold comprising a first core and at least one first lifter obliquely and slidably disposed on the first core, and a temporary mold disposed between the female mold and the first male mold, wherein the temporary mold covers at least one first boundary between the first core and the at least one first lifter of the first male mold in a contacting manner, at least one first molding chamber is defined by the female mold, the first male mold and the temporary mold, and the at least one first boundary is located outside the at least one first molding chamber;
performing a first injection into the at least one first molding chamber to mold a first portion of the product comprising at least one of the at least one turning part;
removing the temporary mold;
replacing the first male mold with a second male mold comprising a second core and at least one second lifter obliquely and slidably disposed on the second core, wherein the first portion of the product covers at least one second boundary between the second core and the at least one second lifter of the second male mold in a contacting manner, a second molding chamber is defined by the female mold, the second male mold and the first portion of the product, and the at least one second boundary is located outside the second molding chamber; and
performing a second injection into the second molding chamber to mold a second portion of the product integrally formed with the first portion of the product, so as to mold the completed product.

9. The product of claim 8, wherein the temporary mold is connected to the first male mold, and removing the temporary mold comprising:
removing the temporary mold by replacing the first male mold with the second male mold.

10. The product of claim 8, wherein the temporary mold is connected to the female mold, and removing the temporary mold comprising:
removing the temporary mold by replacing the female mold with another female mold.

11. The product of claim 8, wherein performing the first injection into the at least one first molding chamber to mold the first portion of the product comprising the at least one of the at least one turning part comprising:
performing the first injection into the at least one first molding chamber with a transparent material to mold the first portion of the product comprising the at least one of the at least one turning part.

12. The product of claim 8, wherein performing the second injection into the second molding chamber to mold the second portion of the product integrally formed with the first portion of the product, so as to mold the completed product comprising:
performing the second injection into the second molding chamber with a transparent material to mold the second portion of the product integrally formed with the first portion of the product, so as to mold the completed product.

13. The product of claim 8, wherein replacing the first male mold with the second male mold comprising the second core and the at least one second lifter obliquely and slidably disposed on the second core comprising:
providing the second male mold rotated from the first male mold by 180 degrees.

14. The product of claim 8, wherein the at least one turning part comprises a plurality of turning parts, and performing the first injection into the at least one first molding chamber to mold the first portion of the product comprising the at least one of the at least one turning part comprises:
performing the first injection into the at least one first molding chamber to mold the first portion of the product comprising the plurality of turning parts at different times or at one time.

15. A molding device manufacturing a product comprising at least one turning part comprising at least one of an undercut part and a right-angle part by a method comprising:
providing a female mold, a first male mold comprising a first core and at least one first lifter obliquely and slidably disposed on the first core, and a temporary mold disposed between the female mold and the first male mold, wherein the temporary mold covers at least one first boundary between the first core and the at least one first lifter of the first male mold in a contacting manner, at least one first molding chamber is defined by the female mold, the first male mold and the temporary mold, and the at least one first boundary is located outside the at least one first molding chamber;
performing a first injection into the at least one first molding chamber to mold a first portion of the product comprising at least one of the at least one turning part;
removing the temporary mold;
replacing the first male mold with a second male mold comprising a second core and at least one second lifter obliquely and slidably disposed on the second core, wherein the first portion of the product covers at least one second boundary between the second core and the at least one second lifter of the second male mold in a contacting manner, a second molding chamber is defined by the female mold, the second male mold and the first portion of the product, and the at least one second boundary is located outside the second molding chamber; and
performing a second injection into the second molding chamber to mold a second portion of the product integrally formed with the first portion of the product, so as to mold the completed product.

16. The molding device of claim 15, wherein the temporary mold is connected to the first male mold, and removing the temporary mold comprising:
removing the temporary mold by replacing the first male mold with the second male mold.

17. The molding device of claim 15, wherein the temporary mold is connected to the female mold, and removing the temporary mold comprising:
removing the temporary mold by replacing the female mold with another female mold.

18. The molding device of claim 15, wherein performing the first injection into the at least one first molding chamber to mold the first portion of the product comprising the at least one of the at least one turning part comprising:
performing the first injection into the at least one first molding chamber with a transparent material to mold the first portion of the product comprising the at least one of the at least one turning part.

19. The molding device of claim 15, wherein performing the second injection into the second molding chamber to mold the second portion of the product integrally formed with the first portion of the product, so as to mold the completed product comprising:
performing the second injection into the second molding chamber with a transparent material to mold the second portion of the product integrally formed with the first portion of the product, so as to mold the completed product.

20. The molding device of claim 15, wherein replacing the first male mold with the second male mold comprising the second core and the at least one second lifter obliquely and slidably disposed on the second core comprising:
providing the second male mold rotated from the first male mold by 180 degrees.

21. The molding device of claim 15, wherein the at least one turning part comprises a plurality of turning parts, and performing the first injection into the at least one first molding chamber to mold the first portion of the product comprising the at least one of the at least one turning part comprises:
performing the first injection into the at least one first molding chamber to mold the first portion of the product comprising the plurality of turning parts at different times or at one time.
